(19) United States
(12) Patent Application Publication
(10) Pub. No.: US 2026/0236031 A1
(43) Pub. Date: Aug. 13, 2026

(54) COLLISION AVOIDANCE AT BLIND INTERSECTION FOR PAYLOAD-CARRYING BIPEDAL ROBOT AND RELATED TECHNOLOGY

(71) Applicant: Agility Robotics, Inc., Pittsburgh, PA (US)

(72) Inventors: Ryan Domres, Albany, OR (US); Andrew Abate, Albany, OR (US); Tianyao Chen, Pittsburgh, PA (US); Jay Jasper, Albany, OR (US); Ezm Masoud, Kitchener (CA); Kevin Reese, Johannesburg, MI (US); Brian Kirby, Pittsburgh, PA (US); Melonee Wise, San Jose, CA (US); Prasanna Velagapudi, Pittsburgh, PA (US)

(21) Appl. No.: 19/070,313

(22) Filed: Mar. 4, 2025

Related U.S. Application Data
(60) Provisional application No. 63/757,642, filed on Feb. 12, 2025.

(51) Int. Cl. G05D 1/633

(52) U.S. Cl. CPC G05D 1/633

(57) ABSTRACT

A method in accordance with at least some embodiments of the present technology includes ambulating a mobile robot within an aisle toward an intersection between the aisle and a safety region of the environment while the mobile robot carries an object that projects from a body of the mobile robot toward the intersection. The method further includes reducing a projection of the object from the body toward the intersection after ambulating the mobile robot toward the intersection. The method also includes moving a sensor of the mobile robot into the safety region after reducing the projection of the object from the body toward the intersection. The method still further includes gathering, via the sensor, information relevant to a collision risk at the safety region. Finally, the method includes moving the object into the safety region based at least partially on the information.

### CROSS-REFERENCE TO RELATED APPLICATION

This claims the benefit of U.S. Provisional Application No. 63/757,642, filed Feb. 12, 2025. The foregoing application is incorporated herein by reference in its entirety. To the extent the foregoing application or any other material incorporated by reference conflicts with the present disclosure, the present disclosure controls.

### TECHNICAL FIELD

The present technology relates to control of mobile robots.

### BACKGROUND

Much of the work that humans currently perform is amenable to automation using robotics. For example, many human workers currently focus on executing predefined movements of items and containers at order-fulfillment centers. Such predefined movements may occur millions of times a day at a single order-fulfillment center and billions of times a day across a network of order-fulfillment centers. Human effort is better suited to more complex tasks, particularly those involving creativity, advanced problem solving, and social interaction. Presently, however, the need for order-fulfillment centers is large and rapidly increasing. Some analysts forecast a shortage of a million or more workers to staff order-fulfillment centers within the next ten to fifteen years. Due to the importance of this field, even small improvements in efficiency have major impacts on macroeconomic productivity. For at least these reasons, there is a significant and growing need for innovation that supports automating tasks that humans currently perform at order-fulfillment centers and elsewhere.

### BRIEF DESCRIPTION OF THE DRAWINGS

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous features may be omitted when the appropriate reference-number labels for such analogous features are clear in the context of the specification and all of the drawings considered together. Furthermore, the same reference numbers may be used to identify analogous features in multiple described embodiments.

FIG. 1 is a perspective view of an environment relevant to methods in accordance with at least some embodiments of the present technology.

FIGS. 2-4 are, respectively, a first perspective view, a second perspective view, and a front profile view of a mobile robot relevant to methods in accordance with at least some embodiments of the present technology.

FIG. 5 is a block diagram corresponding to a method in accordance with at least some embodiments of the present technology.

FIGS. 6-11 are sets individually including a top plan view and a corresponding perspective view of the mobile robot of FIGS. 2-4 in the environment of FIG. 1 at successive respective times during an example of the method of FIG. 5.

FIGS. 12-15 are sets individually including a top plan view and a corresponding perspective view of the mobile robot of FIGS. 2-4 in the environment of FIG. 1 at successive respective times during another example of the method of FIG. 5.

FIGS. 16-19 are sets individually including a top plan view and a corresponding perspective view of the mobile robot of FIGS. 2-4 in the environment of FIG. 1 at successive respective times during another example of the method of FIG. 5.

FIGS. 20-23 are sets individually including a top plan view and a corresponding perspective view of the mobile robot of FIGS. 2-4 in the environment of FIG. 1 at successive respective times during another example of the method of FIG. 5.

FIG. 24 is a block diagram corresponding to another method in accordance with at least some embodiments of the present technology.

FIG. 25 is a block diagram corresponding to another method in accordance with at least some embodiments of the present technology.

FIG. 26 is a block diagram depicting a system including electrical, computer, and software components operably associated with the mobile robot of FIGS. 2-4 and the environment of FIG. 1.

FIG. 27 is a block diagram depicting software architecture and associated portions of the system of FIG. 26.

### DETAILED DESCRIPTION

Disclosed herein are methods, devices, and systems related to controlling mobile robots. Recent advances in robot control, including those involving artificial intelligence, have dramatically increased the capability of mobile robots to perform useful work in environments originally designed for human workers. Fully automating such environments, however, remains many years in the future. Currently, it would be desirable for mobile robots and humans to work in the same environments with the former executing some tasks and the latter executing other tasks. Such collaborative environments are potentially very flexible and efficient, but present certain technical challenges. Perhaps most significantly, collaborative environments call for innovation to ensure the safety of human occupants. Mobile robots, like other types of machinery, have the potential to harm humans. One current strategy for hazard mitigation in collaborative environments involves segregation. For example, mobile robots can be confined to enclosed workcells that humans cannot access. This approach, however, greatly reduces the productive potential of mobile robots. For example, the tasks that mobile robots facilitate often involve direct interaction with humans. Furthermore, even when humans and mobile robots work independently, it is desirable in most cases for the humans and the mobile robots to share certain spaces (e.g., aisles, walkways, material-distribution hubs, etc.). Such sharing promotes the efficient utilization of floorspace in order fulfillment centers and other environments and reduces or eliminates the need to erect and move workcell barriers. For at least these reasons, the segregation strategy is suboptimal.

Another strategy for hazard mitigation in collaborative environments involves detection. In some cases, a mobile robot may be able to transition from a hazardous state to a non-hazardous state (or at least to a less hazardous state) when it detects that a human is nearby. This strategy also has significant limitations. One important limitation relates to blind intersections where regions of an environment meet and where sight lines between the regions are obstructed. As a further challenge, many mobile robots, especially bipedal mobile robots, are designed to carry large payloads anteriorly and to ambulate antegrade, as are humans. When a mobile robot carrying a large payload anteriorly ambulates antegrade within an aisle to a blind intersection between the aisle and a neighboring region of an environment, sensing a human approaching the blind intersection may be especially challenging. If the mobile robot advances directly into the neighboring region there may be a period of time when the payload projects into the neighboring region and, simultaneously, a sight line from a sensor of the mobile robot to a human in the neighboring region is obstructed. Even if the mobile robot slows down significantly as it enters the neighboring region, there is a nonnegligible potential for a collision with the human. Such a collision can occur, for example, if the human is distracted and/or is not following safety protocols. This is unacceptable, even if it occurs rarely. Accordingly, new approaches to avoiding collisions at blind intersections are needed.

Methods, devices, and systems in accordance with at least some embodiments of the present technology include innovation that promotes one or more useful objectives in the field of robotics, particularly collaborative robotics. Such objectives may include facilitating the safe movement of mobile robots through blind intersections in environments shared with humans. In an example, a method in accordance with at least some embodiments of the present technology includes ambulating a mobile robot within an aisle of an environment while the mobile robot carries an object and while the object projects from a body of the mobile robot toward a blind intersection between the aisle and a neighboring region of the environment. The method further includes reducing projection of the object from the body toward the intersection. This can include repositioning the object and/or repositioning at least a portion of the mobile robot relative to the intersection. Then, while projection of the object into the neighboring region is reduced, the method can include moving a sensor of the mobile robot into the neighboring region. The method can also include gathering information via the sensor to inform a strategy for moving the mobile robot into the neighboring region via the intersection. For example, the mobile robot may determine that no human is approaching the intersection and that it is safe, therefore, to enter the neighboring region via the intersection immediately. Alternatively, the mobile robot may determine that a human is near the intersection and that entering the neighboring region via the intersection should be delayed.

As another example, a method in accordance with at least some embodiments of the present technology includes retrieving an object via a mobile robot and then ambulating the mobile robot retrograde within an aisle of an environment to an intersection between the aisle and a neighboring region of the environment. This can cause the mobile robot to have a desirable orientation for sensing a human near the intersection with little or no need to reorient the object or the mobile robot relative to the intersection. Then, after or while the mobile robot moves into the neighboring region via the intersection, the mobile robot can transition to ambulating antegrade. The mobile robot can then continue ambulating antegrade to a placing location within the environment. Relative to retrograde ambulation, antegrade ambulation may have certain advantages, such as greater efficiency, stability, and legibility. Moreover, antegrade ambulation may cause the mobile robot to approach a placing location in a desirable orientation for a placing operation. As yet another example, a method in accordance with at least some embodiments of the present technology includes gathering information about a collision risk at a blind intersection via a sensor at an end effector of the mobile robot while the mobile robot carries the object via the end effector. In still another example, a method in accordance with at least some embodiments of the present technology includes gathering information about a collision risk at a blind intersection by implementing a deep-bow maneuver while the mobile robot 200 faces the intersection. These and other approaches to avoiding collisions at blind intersections have the potential to significantly increase the feasibility of collaborative environments.

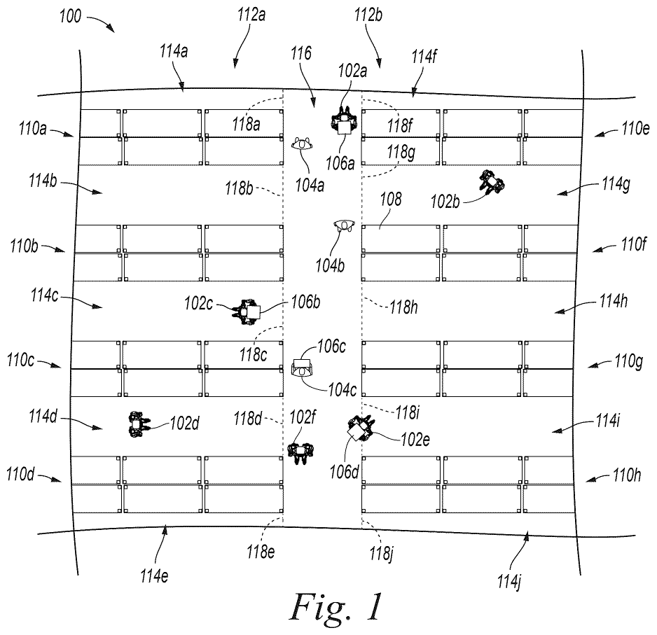

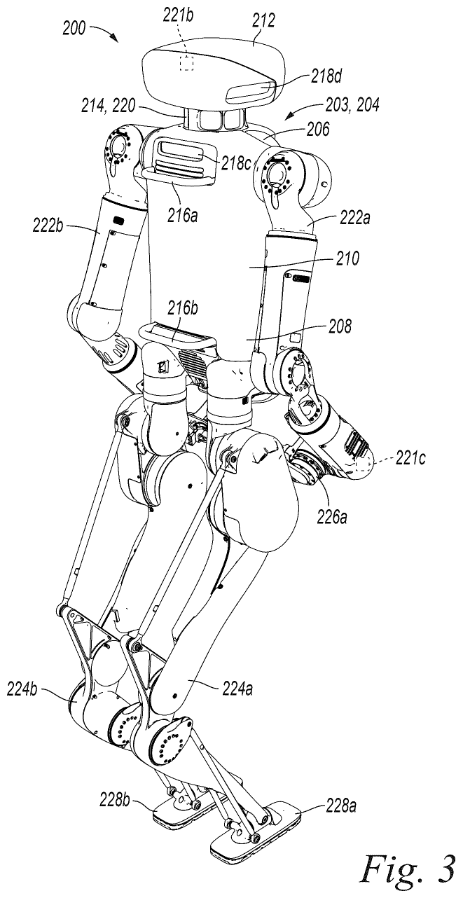

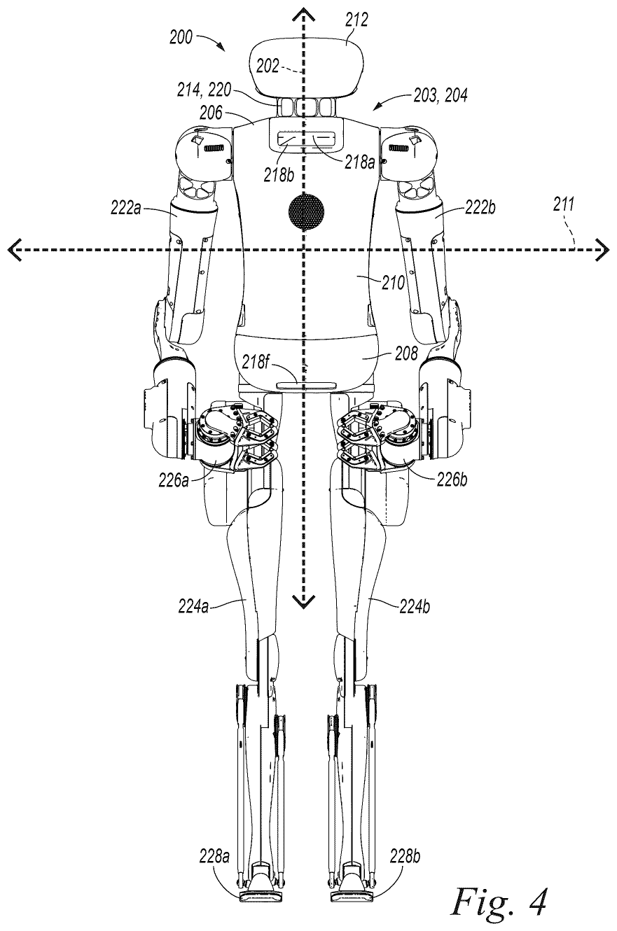

The foregoing and many other features of methods, devices, and systems in accordance with various embodiments of the present technology are further described below with reference to FIGS. 1-27 Although methods, devices, and systems may be described herein primarily or entirely in the context of bimanual, bipedal robots, other contexts are within the scope of the present technology. For example, suitable features of described methods, devices, and systems can be implemented in the context of mobile robots with one arm, in the context of mobile robots with more than two arms, and/or in the context of non-legged mobile robots. Accordingly, the word “bipedal” as used herein may be replaced with “mobile” to encompass non-bipedal counterparts within the present technology unless the context clearly indicates otherwise. Furthermore, it should be understood, in general, that other methods, devices, and systems in addition to those disclosed herein are within the scope of the present technology. For example, methods, devices, and systems in accordance with embodiments of the present technology can have different and/or additional configurations, components, procedures, etc. than those disclosed herein. Moreover, methods, devices, and systems in accordance with embodiments of the present technology can be without one or more of the configurations, components, procedures, etc. disclosed herein without deviating from the present technology.

### Examples of Environments

FIG. 1 is a perspective view of an environment 100 relevant to methods in accordance with at least some embodiments of the present technology. As shown in FIG. 1, the environment 100 can include mobile robots 102a-102f and humans 104a-104c. Some of the mobile robots 102a-102f and humans 104a-104c carry objects 106a-106d. Others do not. As mentioned above and as further discussed below, the mobile robots 102a-102f can be configured to carry objects anteriorly and to ambulate antegrade. Humans also typically carry objects anteriorly and ambulate antegrade in normal circumstances. Indeed, object-handling features of the mobile robots 102a-102f may be related to facilitating motion legibility and integration of the mobile robots 102a-102f into environments built or otherwise organized for humans. The environment 100 can also include static structures. In the illustrated case, the environment 100 includes shelving units 108 (one labeled) grouped in bays 110a-110h arranged in rows 112a, 112b. The environment 100 can also include aisles 114a-114j between different respective bays 110a-110h neighboring one another within one of the rows 112a, 112b. The environment 100 can also include a shared region 116 between the rows 112a, 112b. Finally, the environment 100 can include intersections 118a-118j between the aisles 114a-114j and the shared region 116, respectively.

The shared region 116 can be a central aisle through which the aisles 114a-114j are interconnected. Relatedly, the shared region 116 can be a collector region intended to be used at least primarily for through travel. In contrast, the aisles 114a-114j can be intended for use at least primarily for placing, retrieving, and/or storing objects. In the illustrated case, the individual aisles 114a-114j and the shared region 116 are elongate. Also in the illustrated case, the aisles 114a-114j are perpendicular to the shared region 116 lengthwise. In other cases, counterparts of the aisles 114a-114j and of the shared region 116 can have other suitable forms, arrangements, etc. For example, the row 112b, the aisles 114f-114j, and the intersections 118g-118j can be omitted. As another example, the row 112a, the aisles 114a-114e, and the intersections 118a-118e can be omitted. As yet another example, a counterpart of the shared region 116 can be a concourse, hub, or other open area rather than an aisle. Moreover, numerous other forms of sight-line obstruction at the intersections 118a-118j are possible. For example, equipment can take the place of some of all of the shelving units 108. Relatedly, the arrangement of the environment 100 need not be static. For example, counterparts of the shelving units 108 can be mobile. In these and other cases, counterparts of the intersections 118a-118j can be dynamic with blind intersections forming transiently as sources of sight-line obstruction move.

With reference again to FIG. 1, the aisles 114a-114j and the shared region 116 can have different occupancy characteristics. For example, the aisles 114a-114j can be designated as off limits to humans whereas the shared region 116 is intended for simultaneous occupancy by both mobile robots and humans. Alternatively, the aisles 114a-114j and the shared region 116 can all be intended for simultaneous occupancy by both mobile robots and humans. Relatedly, the intersections 118a-118j can be marked or unmarked. Other configurations are also possible. Furthermore, the intersections 118a-118j can be “blind” because the shelving units 108 at the intersections 118a-118j obstruct sight lines between the corresponding aisles 114a-114j and the shared region 116. The term “intersection” as used herein refers to an interface between neighboring regions of an environment with different shape and/or traffic characteristics. An intersection may exist at a four-way junction (e.g., the junction of the aisles 114b, 114g and the shared region 116 in the environment 100), a two-way junction (e.g., a simple corner), a three-way junction (e.g., a tee), and in other cases. Counterparts of the environment 100 can include such alternative intersections and/or other features in addition or instead of the features shown in FIG. 1.

### Examples of Mobile Robots

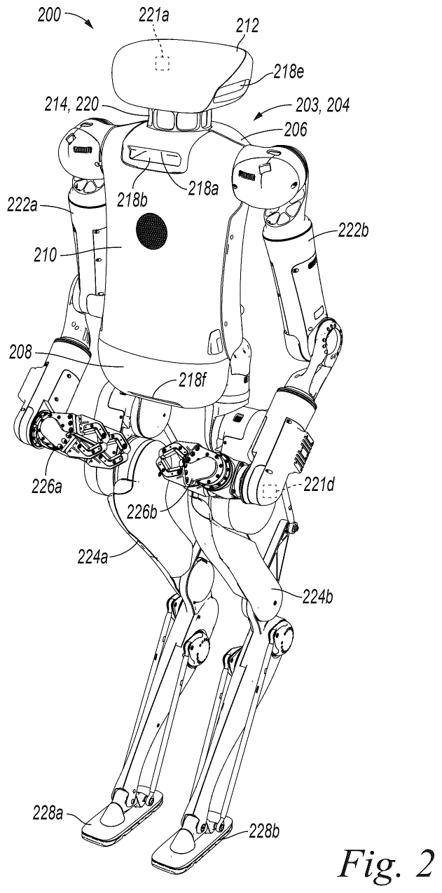

FIGS. 2-4 are, respectively, a first perspective view, a second perspective view, and a front profile view of a mobile robot 200 relevant to methods in accordance with at least some embodiments of the present technology. The mobile robot 200 can correspond to the mobile robots 102a-102f discussed above in the context of FIG. 1. With reference now to FIGS. 2-4 together, the mobile robot 200 can include structures resembling human anatomy with respect to the features, positions, or other characteristics of such structures. In at least some cases, the mobile robot 200 defines a midsagittal plane 202 about which the mobile robot 200 is bilaterally symmetrical. In these and other cases, the mobile robot 200 can be configured for bipedal locomotion similar to that of a human. The mobile robot 200 can further define a coronal plane (not shown) perpendicular to the midsagittal plane 202. Counterparts of the mobile robot 200 can have other suitable forms and features. For example, a counterpart of the mobile robot 200 can have a non-humanoid form, such as a canine form, an insectoid form, an arachnoid form, or a form with no animal analog. Furthermore a counterpart of the mobile robot 200 can be asymmetrical or have symmetry other than bilateral. Still further, a counterpart of the mobile robot 200 can be configured for non-bipedal locomotion. For example, a counterpart of the mobile robot 200 can be configured for another type of legged locomotion (e.g., quadrupedal locomotion, hexapedal locomotion, octopedal locomotion, etc.) or non-legged locomotion (e.g., wheeled locomotion, continuous-track locomotion, etc.).

With reference again to FIGS. 2-4, the mobile robot 200 can include a centrally disposed body 203 through which other structures of the mobile robot 200 are interconnected. As all or a portion of the body 203, the mobile robot 200 can include a torso 204 having a superior portion 206, an inferior portion 208, and an intermediate portion 210 therebetween. The mobile robot 200 can define a transverse plane 211 from which the superior and inferior portions 206, 208 of the torso 204 are respectively superiorly and inferiorly spaced apart. The transverse plane 211 can be perpendicular to the midsagittal plane 202 and perpendicular to the coronal plane. The mobile robot 200 can further include a head 212 superiorly spaced apart from the torso 204. The mobile robot 200 can also include a neck 214 through which the head 212 is connected to the torso 204 via the superior portion 206 of the torso 204. The mobile robot 200 can still further include handles 216a, 216b extending, respectively, posteriorly from the superior portion 206 of the torso 204 and posteriorly from the inferior portion 208 of the torso 204.

The mobile robot 200 can also include elongate sensor bays 218 (individually identified as elongate sensor bays 218a-218f) carried by the torso 204 and the head 212. The elongate sensor bay 218a can be at an anterior side of the superior portion 206 of the torso 204 and tilted inferiorly. The elongate sensor bay 218b can be inferiorly adjacent to the elongate sensor bay 218a at the anterior side of the superior portion 206 of the torso 204 and less tilted than the elongate sensor bay 218a. The elongate sensor bay 218c can be at a posterior side of the superior portion 206 of the torso 204 and posteriorly directed. The elongate sensor bays 218d, 218e can be at opposite respective sides of the head 212 and can be directed in opposite respective lateral directions. The elongate sensor bay 218f can be at the inferior portion 208 of the torso 204 and directed anteriorly and inferiorly toward a ground level in front of the mobile robot 200. The mobile robot 200 can further include a cylindrical sensor bay 220 at the neck 214. The mobile robot 200 can also include additional sensor bays 221a, 221b (shown schematically) anteriorly and posteriorly directed, respectively, and carried the mobile robot 200 at anterior and posterior portions, respectively, of the head 212. The mobile robot 200 can also include additional sensor bays 221c, 221d (also shown schematically) laterally directed and carried the mobile robot 200 at distal end portions of the arms 222a, 222b, respectively.

At the elongate sensor bays 218a-218f, at the cylindrical sensor bay 220, and at the additional sensor bays 221a-221d, the mobile robot 200 can include perception sensors through which the mobile robot 200 can receive information about an environment in which it operates. The perception sensors can emit and/or receive optical, audio, electromagnetic, and/or other types of signals. Examples of suitable perception sensors include cameras (e.g., red-green-blue (RGB) cameras, infrared cameras, stereoscopic cameras, etc.), light detection and ranging (LIDAR) sensors, and sound navigation and ranging (SONAR) sensors. In a particular example, the mobile robot 200 includes cameras at the elongate sensor bays 218a-218f, a LIDAR sensor at the cylindrical sensor bay 220, and more cameras the additional sensor bays 221a-221d. Additional details regarding sensors of the mobile robot 200 are provided below in connection with a broader discussion of electrical, computer, and software components operably associated with the mobile robot 200. Moreover, the elongate sensor bays 218a-218f, the cylindrical sensor bay 220, and the additional sensor bays 221a-221d need not have any particular form. In a counterpart of the mobile robot 200, at least some of the elongate sensor bays 218a-218f can be non-elongate, the cylindrical sensor bay 220 can be non-cylindrical, etc.

With reference again to the illustrated embodiment, the mobile robot 200 can further include articulated appendages carried by the torso 204. Among these articulated appendages, the mobile robot 200 can include arms 222 (individually identified as arms 222a, 222b) and legs 224 (individually identified as legs 224a, 224b). The mobile robot 200 can also include joints (not labeled) between the arms 222a, 222b and the torso 204, between the legs 224a, 224b and the torso 204, and at individual articulations of the arms 222a, 222b and of the legs 224a, 224b. The mobile robot 200 can further include actuators (also not labeled) operably associated with the joints. The individual actuators can be rotary and include a motor and gearing (e.g., cycloidal gearing, strain-wave gearing, or planetary gearing) or linear. The actuators can be disposed at the corresponding joints directly or operably associated with the corresponding joints in another suitable manner, such as via a cable, via a connection rod, or within a four-bar linkage.

In at least some cases, the mobile robot 200 is configured to manipulate objects via the arms 222a, 222b, such as bimanually. In these and other cases, the mobile robot 200 can be configured to ambulate via the legs 224a, 224b, such as bipedally. Thus, the mobile robot 200 can be bimanual and bipedal. The arms 222a, 222b and the legs 224a, 224b can separately extend from the body 203 and define kinematic chains. The kinematic chains corresponding to the arms 222a, 222b can provide at least five degrees of freedom, such as exactly five or exactly six degrees of freedom. The kinematic chains corresponding to the legs 224a, 224b can provide at least four degrees of freedom, such as exactly four, exactly five, or exactly six degrees of freedom. As parts of the arms 222a, 222b, the mobile robot 200 can include end effectors 226a, 226b at distalmost portions of the corresponding kinematic chains. Similarly, as parts of the legs 224a, 224b, the mobile robot 200 can include feet 228a, 228b at distalmost portions of the corresponding kinematic chains. Thus, the arms 222a, 222b and legs 224a, 224b can distally carry the end effectors 226a, 226b and the feet 228a, 228b, respectively. Relatedly, the legs 224a, 224b can carry the body 203 via the inferior portion 208 of the torso 204. Likewise, the feet 228a, 228b can carry the body via the legs 224a, 224b. In some cases, the additional sensor bay 221c and the end effector 226a are at opposite respective sides of the distal end portion of the arm 222a. Similarly, the additional sensor bay 221d and the end effector 226b can be at opposite respective sides of the distal end portion of the arm 222b.

As mentioned above, a counterpart of the mobile robot 200 can be a wheeled mobile robot including one or more wheels instead of or in addition to the feet 228a, 228b. The one or more wheels can be configured to interact with a ground surface while the wheeled mobile robot is in motion. In an example, the wheeled mobile robot is the same as or similar to the mobile robot 200 superior to the feet 228a, 228b. Instead of the feet 228a, 228b, the wheeled mobile robot can include a wheeled base. The legs 224a, 224b can extend between the wheeled base and the body 203. In another example, a single counterpart of the legs 224a, 224b can extend between the wheeled base and the body 203. Like the mobile robot 200 as illustrated, the wheeled mobile robot counterpart can be dynamically stable in that it relies on active control to maintain stability during normal operation. This is typical, for example, when an overall footprint of the wheeled base on the ground surface is relatively small. The active control can be implemented at least partially by changing respective poses of links of the wheeled mobile robot superior to the wheeled base. It should be understood that the wheeled mobile robot counterpart can be substituted for the mobile robot 200 in descriptions herein of at least some embodiments of the present technology unless the context clearly indicates otherwise.

### Examples of Methods

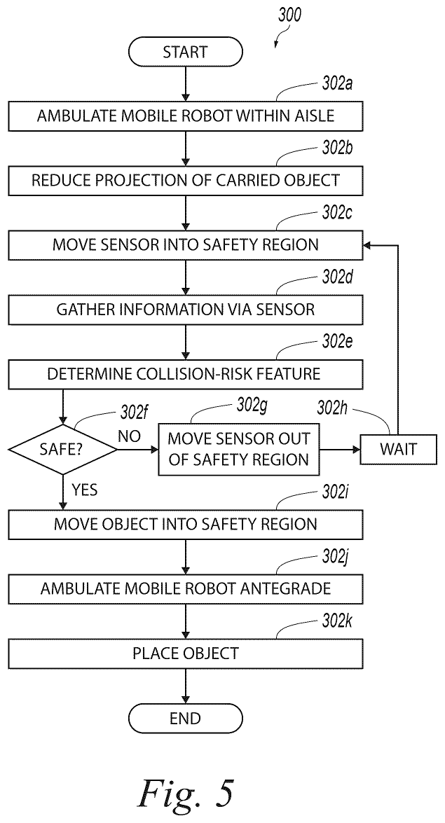

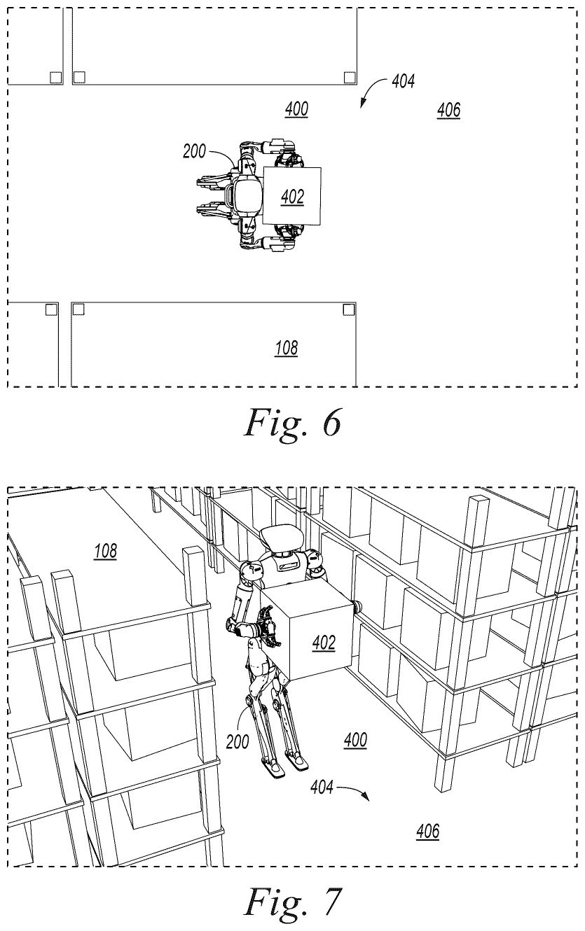

FIG. 5 is a block diagram corresponding to a method 300 in accordance with at least some embodiments of the present technology. The diagram includes blocks 302a-302k corresponding to different respective portions of the method 300. FIGS. 6-11 are sets individually including a top plan view and a corresponding perspective view of the mobile robot 200 in the environment 100 at successive respective times during an example of the method 300. With reference to FIGS. 1-11 together, the method 300 can include ambulating (e.g., bipedally ambulating) the mobile robot 200 within an aisle 400 (block 302a). This can occur while the mobile robot 200 carries an object 402. In at least some cases, the environment 100 includes a picking location (not shown) at the aisle 400 or elsewhere from which the mobile robot 200 retrieves the object 402 before ambulating within the aisle 400. In these and other cases, the ambulating can occur while the object 402 projects from the body 203 toward an intersection 404 between the aisle 400 and a safety region 406 of the environment 100. Furthermore, the ambulating can occur while the object 402 is anterior relative to the body 203 and anterior relative to the legs 224a, 224b. The aisle 400, the object 402, and the intersection 404 can correspond, respectively, to any of the aisles 114a-114j, the objects 106a-106d, and the intersections 118a-118j discussed above in the context of FIG. 1. The safety region 406 can correspond to all or a portion of the shared region 116 (FIG. 1) neighboring a given one of the aisles 114a-114j at the corresponding one of the one of the intersections 118a-118j. Furthermore, while the object 402 in the illustrated case is a box, in other cases, the object 402 can be a tote, a crate, a singulated hardgood, a singulated softgood, or have another suitable form.

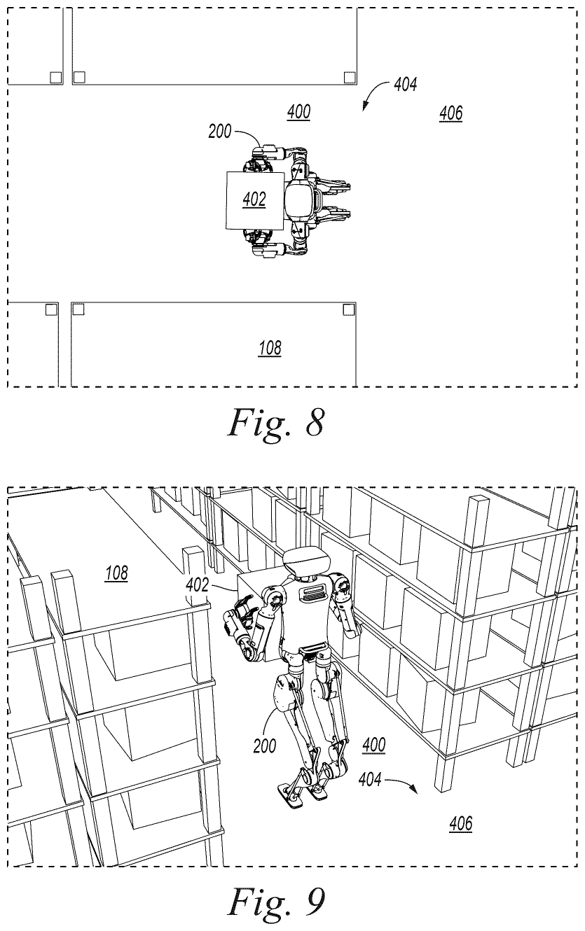

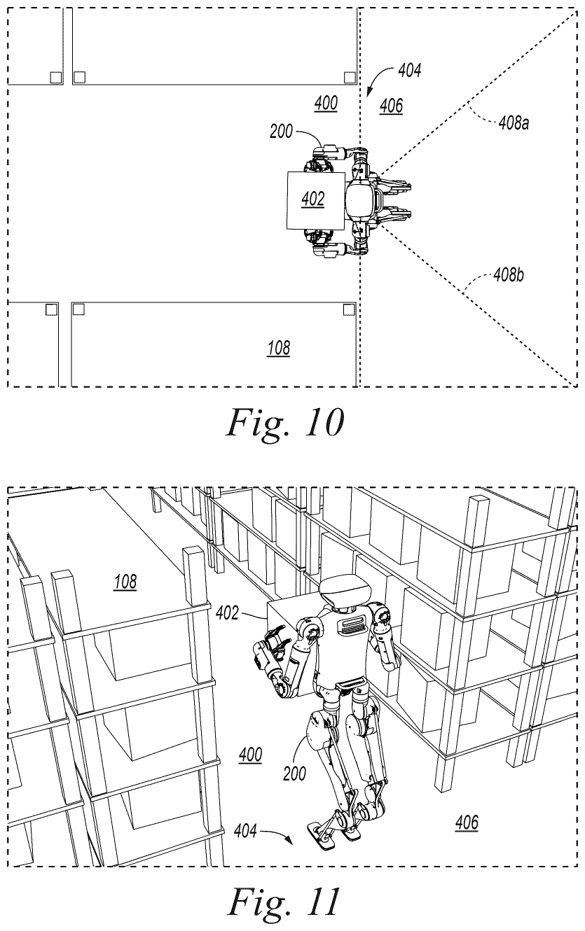

The method 300 can further include reducing a projection of the object 402 from the body 203 toward the intersection 404 (block 302b) after ambulating the mobile robot 200 toward the intersection 404. This can occur while the mobile robot 200 carries the object 402 via the arms 222a, 222b. As shown in FIGS. 8 and 9 relative to FIGS. 6 and 7, reducing the projection of the object 402 can include reorienting both the mobile robot 200 and the object 402 relative to the intersection 404. In these and other cases, reducing the projection of the object 402 can occur while the mobile robot 200 steps with one or both of the legs 224a, 224b. For example, the mobile robot 200 can perform an about-face maneuver at a portion of the aisle 400 near the intersection 404. Alternatively, the mobile robot 200 can reorient itself more gradually as it approaches the intersection 404. The method 300 can also include moving a sensor of the mobile robot 200 into the safety region 406 (block 302c) after reducing the projection of the object 402. As shown in FIGS. 10 and 11 relative to FIGS. 8 and 9, this can include ambulating the mobile robot 200 retrograde into the safety region 406. The sensor that moves into the safety region 406 can be a sensor at one of the elongate sensor bays 218d, 218e. Likewise, the method 300 can include moving a sensor of the mobile robot 200 at the other of the elongate sensor bays 218d, 218e into the safety region 406. Once moved into the safety region 406, the sensors can have respective visibility regions 408a, 408b sufficiently unobstructed to detect a human within the safety region 406.

After the sensor moves into the safety region 406, the method 300 can include gathering information via the sensor while the sensor is in the safety region 406 (block 302d). In at least some cases, this occurs while the object 402 remains in the aisle 400. Thus, the risk of a collision between the object 402 and a human within while gathering the information can be relatively low. The gathered information can be any information relevant to a collision risk at the safety region 406. In an example, the information includes a proximity of a human within the safety region 406, a trajectory of a human within the safety region 406, or both. In this example, the relevant sensor can gather data (e.g., vision data) on the safety region 406 and pass the data to a computing system operably associated with the mobile robot 200. Examples of the computing system and operation thereof are provided below in the context of other figures. The computing system can process the data via a model trained to recognize data patterns corresponding to a human. The computing system can then use features of the data (e.g., color information, depth information, etc.) to determine a proximity, a trajectory, a speed, and/or other information about the human at the time of observation.

Next, the method 300 can include determining a collision-risk feature of the safety region 406 (block 302e) via the computing system. Determining the collision-risk feature can be based at least partially on the gathered information, such as gathered proximity, trajectory, and/or speed information about a human within the safety region 406. In an example, the computing system implements an algorithm for determining the collision-risk feature as an output of a function in which variables about a human within the safety region 406 are inputs. The function can embody heuristics about correspondences between variables (e.g., proximity, trajectory, speed, etc.) and a likelihood of a collision at the safety region 406. As an example, the algorithm may assign a greater collision risk when a human is relatively close to the mobile robot 200 than when a human is relatively far from the mobile robot 200. As another example, the algorithm may assign a greater collision risk when a human is moving toward the mobile robot 200 than when a human is moving away from the mobile robot 200. As another example, the algorithm may assign a greater collision risk when a human is moving relatively fast than when a human is moving relatively slow. As yet another example, the algorithm may assign a greater collision risk when a human's eyes are detected and directed toward the mobile robot 200 than when the human's eyes are not detected and/or not directed toward the mobile robot 200 (e.g., because the human is distracted).

The method 300 can then include using the raw information and/or the collision-risk feature to determine whether moving the object 402 into the safety region 406 is safe (block 302f). If moving the object 402 into the safety region 406 is not safe (e.g., because a collision-risk score is above a threshold, because a human is present in the safety region 406, because a human is approaching the mobile robot 200, etc.) the method 300 can include moving the sensor out of the safety region 406 (block 302g). This can include reversing one or more operations by which the mobile robot 200 moved the sensor into the safety region 406. For example, moving the sensor out of the safety region 406 can include ambulating the mobile robot 200 antegrade when moving the sensor into the safety region includes ambulating the mobile robot 200 retrograde. The method 300 can then include waiting (block 302h) for a suitable period of time (e.g., 5 seconds, 10 seconds, etc.) before repeating the operations of blocks 302c-302f. This can continue until moving the object 402 into the safety region 406 is safe, after which the method 300 can include proceeding to move the object 402 into the safety region 406 (block 302i). Thus, moving the object 402 into the safety region 406 can be based at least partially on information relevant to a collision risk at the safety region 406 and/or a corresponding collision-risk feature.

In at least some cases, moving the object 402 into the safety region 406 includes further ambulating the mobile robot 200 retrograde into the safety region 406. Once the object 402 is inside the safety region 406, the method 300 can include causing the mobile robot 200 to perform another about-face maneuver or to gradually turn around and then ambulate antegrade toward another portion of the environment 100, e.g., a placing location for the placing the object 402. In general, it can be useful for moving the object 402 into the safety region 406 to follow a positive safety determination as quickly as possible to reduce or eliminate the possibility of a new safety hazard emerging in the interim. Correspondingly, it can be useful to reorient the mobile robot 200 within the safety region 406 rather than within the aisle 400 when the mobile robot 200 is facing away from the safety region 406 at the time of the positive safety determination. As mentioned above, after the collision risk at the intersection 404 is no longer present, there can be efficiency, legibility, and/or other advantages to ambulating the mobile robot 200 antegrade and with the object 402 anterior to the body 203. Accordingly, the method 300 can further include ambulating the mobile robot 200 antegrade to a placing location within the environment 100 (block 302j) after moving the object 402 into the safety region 406. The ambulating can be bipedal, via the legs 224a, 224b, and while the object 402 is in contact with at least one of the arms 222a, 222b. Finally, the method 300 can include placing the object 402 at the placing location (block 302k). In at least some cases, this includes moving the object 402 away from the body 203 via at least one of the arms 222a, 222b while the mobile robot 200 is at the placing location.

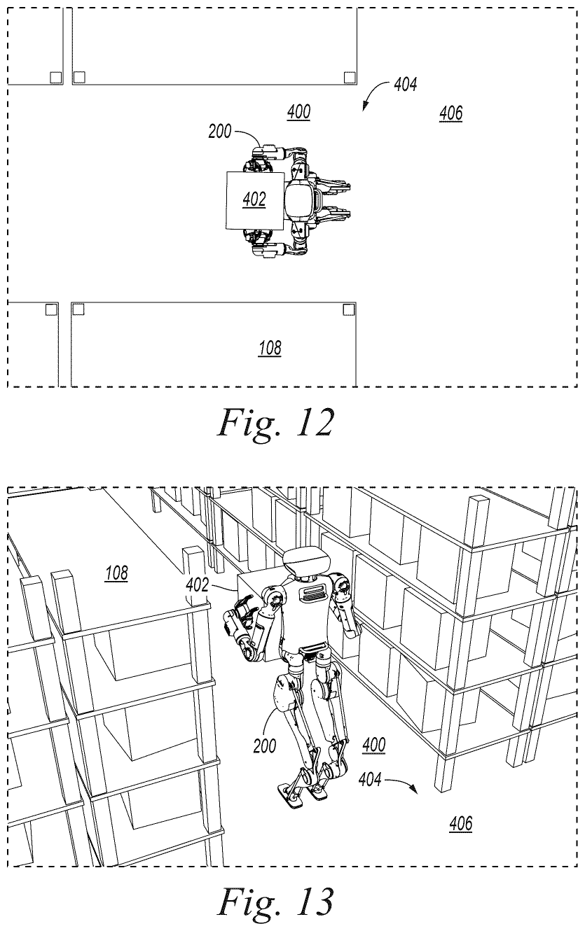

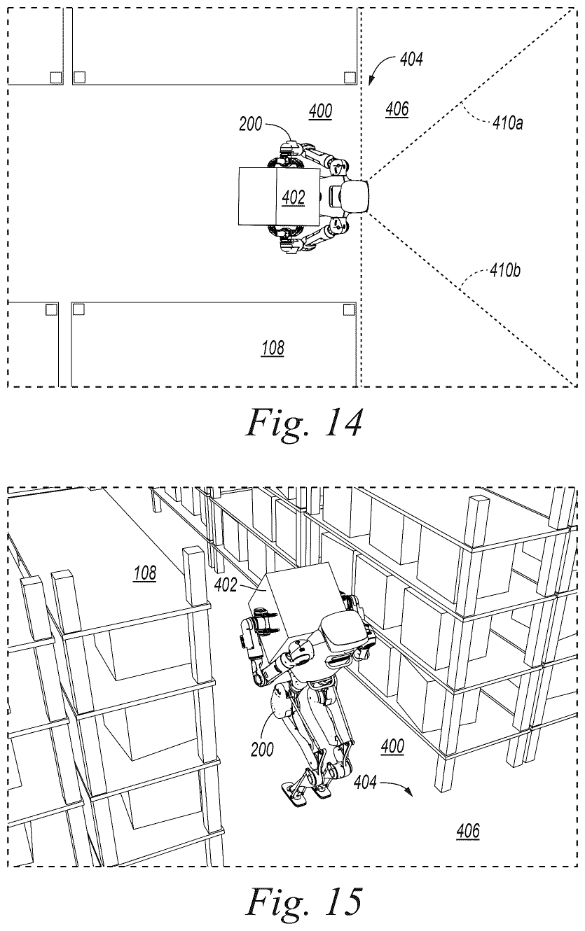

FIGS. 12-15 are sets individually including a top plan view and a corresponding perspective view of the mobile robot 200 in the environment 100 at successive respective times during another example of the method 300. FIGS. 12 and 13 are similar to FIGS. 8 and 9 and represent a time during an example of the method 300 after ambulating the mobile robot 200 within the aisle 400 and after reducing projection of the object 402 toward the intersection 404. At this time, in addition to or instead of ambulating the mobile robot 200 retrograde into the safety region 406 to move the sensor into the safety region 406, the method 300 can include tilting a superior portion of the body 203 (e.g., the superior portion 206 of the torso 204) relative to an inferior portion of the body 203 (e.g., the inferior portion 208 of the torso 204). As shown in FIGS. 14 and 15 with reference to FIGS. 2-4, the tilting can be posterior relative to body 203. Furthermore, the tilting can occur while the feet 228a, 228b are planted in the aisle 400. The sensor that moves into the safety region 406 can be a sensor at one of the elongate sensor bays 218d, 218e. The method 300 can also include moving a sensor of the mobile robot 200 at the other of the elongate sensor bays 218d, 218e into the safety region 406 via the tilting. Once moved into the safety region 406, the sensors can have respective visibility regions 410a, 410b sufficiently unobstructed to detect a human within the safety region 406 even though most of the mobile robot 200 and most or all of the object 402 remain in the aisle 400.

As shown in FIG. 14 relative to FIG. 10, moving the sensor into the safety region 406 by tilting can result in less of the mobile robot 200 being within the safety region 406 prior to a positive safety determination than moving the sensor into the safety region 406 by ambulating the mobile robot 200 retrograde. In some cases, however, tilting has the potential to reduce an overall stability of the mobile robot 200 and/or to increase a fall bias of the mobile robot 200 toward the safety region 406. In these and other cases, the mobile robot 200 can execute one or more movements for enhancing stability and/or for avoiding a fall bias toward the safety region 406 in connection with the tilting. For example, the mobile robot 200 can bend the legs 224a, 224b to lower the body 203 and/or extend the arms 222a, 222b to move the object 402 away from the body 203 in a direction opposite to a direction of the tilting. The method 300 can include reversing these compensating movements when moving the sensor out of the safety region and/or after determining that moving the object 402 into the safety region 406 is safe. Other portions of the method 300 in this example can be the same as or similar to those described above in the context of FIGS. 6-11.

In the illustrated case, the legs 224a, 224b have a persistent posterior bend at the corresponding knee joints. In other cases, a counterpart of the mobile robot 200 may have counterpart legs with a persistent anterior bend at the corresponding knee joints and/or no persistent bend at the corresponding knee joints. In these and other cases, it may be advantageous for the counterpart mobile robot to include laterally directed sensors at a posterior portion of the inferior portion 208 of the torso 204 and/or at posterior and superior portions of the counterpart legs. While the counterpart mobile robot is facing away from the safety region 406, the counterpart mobile robot can cause these sensors to move into the safety region 406. For example, the counterpart mobile robot may bend the knee joints and hip joints of the counterpart legs such that the superior portion 206 of the torso 204 tilts anteriorly and away from the safety region 406. At the same time, the inferior portion 208 of the torso 204 and the superior portions of the counterpart legs can move posteriorly into the safety region 406. Again, these movements can occur while the feet 228a, 228b are planted in the aisle 400. The associated anterior and posterior shifts of the weight of the counterpart mobile robot can counteract one another such that the counterpart mobile robot remains stable. Once moved into the safety region 406, the sensors can have respective visibility regions sufficiently unobstructed to detect a human within the safety region 406 even though most of the counterpart mobile robot and most or all of the object 402 remain in the aisle 400. Other sensor locations and movements to cause the sensors to move into the safety region 406 are also possible.

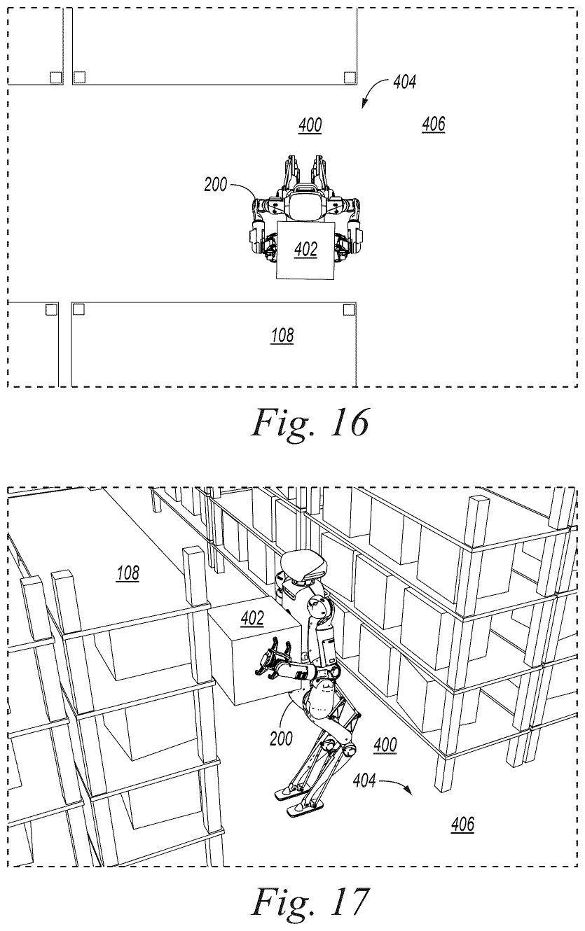

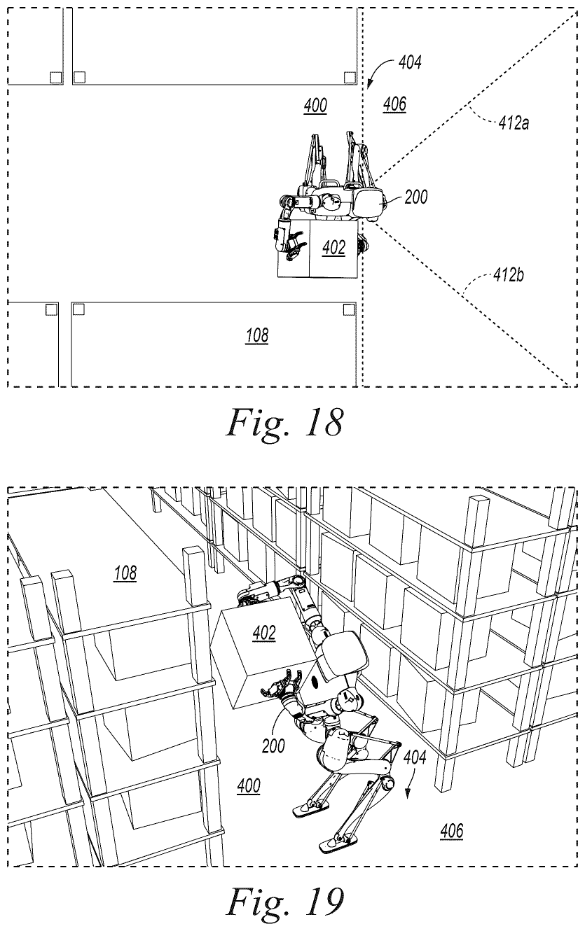

FIGS. 16-19 are sets individually including a top plan view and a corresponding perspective view of the mobile robot 200 in the environment 100 at successive respective times during another example of the method 300. FIGS. 16 and 17 represent a time during an example of the method 300 after ambulating the mobile robot 200 within the aisle 400 and after reducing projection of the object 402 toward the intersection 404. As shown in FIGS. 16 and 17 relative to FIGS. 8 and 9, reducing the projection of the object 402 from the body 203 toward the intersection 404 can include reorienting both the mobile robot 200 and the object 402 about 90 degrees rather than about 180 degrees (e.g., via a quarter turn rather than a half turn) relative to the intersection 404. Again, this can occur at a portion of the aisle 400 near the intersection 404 or more gradually as the mobile robot 200 approaches the intersection 404. As shown in FIGS. 18 and 19, moving the sensor into the safety region 406 from this state can include tilting a superior portion of the body 203 (e.g., the superior portion 206 of the torso 204) laterally relative to an inferior portion of the body 203 (e.g., the inferior portion 208 of the torso 204). The tilting can occur while the feet 228a, 228b are planted in the aisle 400. The sensor that moves into the safety region 406 can be a sensor at one of the additional sensor bays 221a, 221b. The method 300 can also include moving a sensor of the mobile robot 200 at the other of the additional sensor bays 221a, 221b into the safety region 406 via the tilting. Once moved into the safety region 406, the sensors can have respective visibility regions 412a, 412b sufficiently unobstructed to detect a human within the safety region 406 even though most of the mobile robot 200 and most or all of the object 402 remain in the aisle 400.

As shown in FIG. 18 relative to FIG. 10, moving the sensor into the safety region 406 by lateral tilting can result in less of the mobile robot 200 being within the safety region 406 before a positive safety determination than moving the sensor into the safety region 406 by ambulating the mobile robot 200 retrograde. In some cases, however, lateral tilting (as with anterior tilting) has the potential to reduce an overall stability of the mobile robot 200 and/or to increase a fall bias of the mobile robot 200 toward the safety region 406. In these and other cases, the mobile robot 200 can execute one or more movements for enhancing stability and/or for avoiding a fall bias toward the safety region 406 in connection with the lateral tilting. For example, the mobile robot 200 can bend the legs 224a, 224b to lower the body 203 and/or move the arms 222a, 222b to move the object 402 away from the intersection 404. The method 300 can include reversing these compensating movements when moving the sensor out of the safety region and/or after determining that moving the object 402 into the safety region 406 is safe. Other portions of the method 300 in this example can be the same as or similar to those described above in the context of FIGS. 6-11.

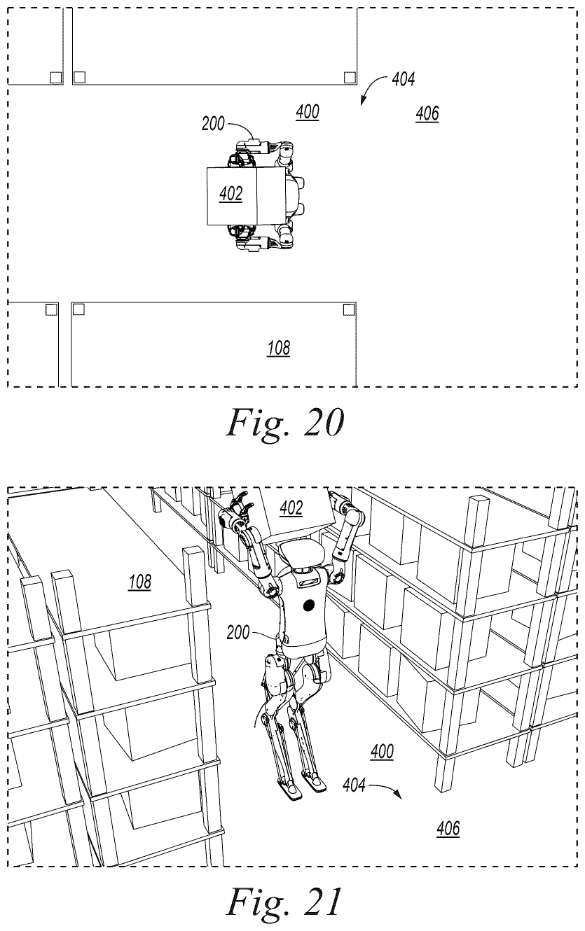

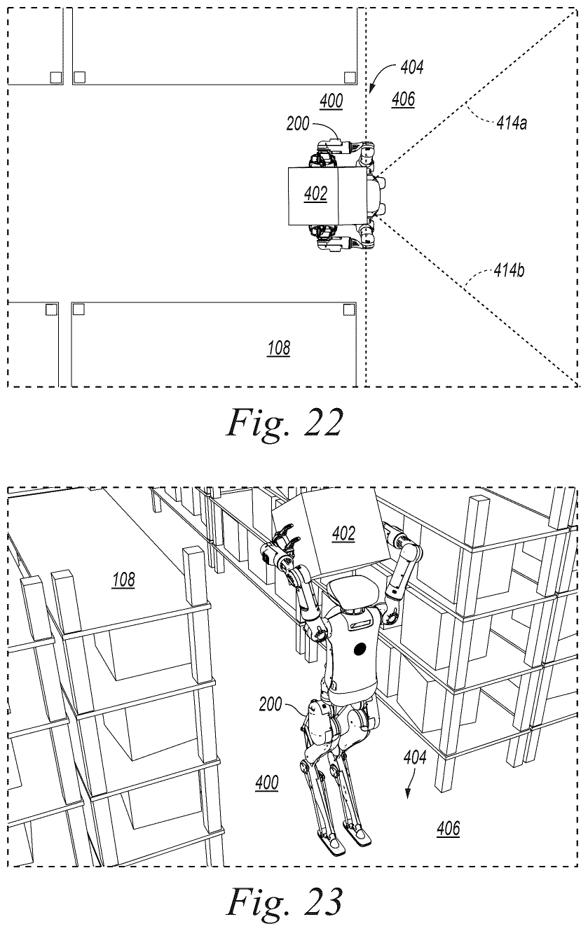

FIGS. 20-23 are sets individually including a top plan view and a corresponding perspective view of the mobile robot 200 in the environment 100 at successive respective times during another example of the method 300. FIGS. 20 and 21 represent a time during an example of the method 300 after ambulating the mobile robot 200 within the aisle 400 and after reducing projection of the object 402 toward the intersection 404. In addition to or instead of moving the entire mobile robot 200 and the object 402 together relative to the intersection 404, reducing the projection of the object 402 from the body 203 toward the intersection 404 in the method 300 can include moving the object 402 relative to the body 203 via the arms 222a, 222b. For example, reducing the projection of the object 402 from the body 203 toward the intersection 404 can occur while rotating the arms 222a, 222b relative to the body 203 and while the mobile robot 200 carries the object 402 via the arms 222a, 222b. As shown in FIGS. 22 and 23, moving the sensor into the safety region 406 from this state can include ambulating the mobile robot 200 antegrade while the object 402 is superior relative to the body 203. The sensor that moves into the safety region 406 can be a sensor at one of the elongate sensor bays 218d, 218e. Likewise, the method 300 can include moving a sensor of the mobile robot 200 at the other of the elongate sensor bays 218d, 218e into the safety region 406. Once moved into the safety region 406, the sensors can have respective visibility regions 414a, 414b sufficiently unobstructed to detect a human within the safety region 406. Other portions of the method 300 in this example can be the same as or similar to those described above in the context of FIGS. 6-11.

In the illustrated example, rotating the arms 222a, 222b relative to the body 203 moves the object 402 from anterior relative to the body 203 to superior relative to the body 203. In other cases, the method 300 can include further rotating the arms 222a, 222b relative to the body 203 to move the object 402 from superior relative to the body 203 to posterior relative to the body 203. In these and other cases, moving the sensor into the safety region 406 can occur while the object 402 is posterior relative to the body 203. Other variations are also possible. For example, the method 300 can include tilting a superior portion of the body 203 (e.g., the superior portion 206 of the torso 204) relative to an inferior portion of the body 203 (e.g., the inferior portion 208 of the torso 204) while the arms 222a, 222b hold the object 402 superior and/or posterior relative to the body 203. This tilting can have any suitable features discussed above for the posterior tilting shown in FIGS. 14 and 15 or for the lateral tilting shown in FIGS. 18 and 19.

In still other examples, reducing the projection of the object 402 from the body 203 toward the intersection 404 can include moving the body 203 and the object 402 relative to the legs 224a, 224b. For example, a counterpart of the mobile robot 200 can include a joint (e.g., a waist joint) through which the body 203 is rotatably connected to the legs 224a, 224b. Movement at this joint can substitute for or supplement ambulatory reorientation of the entire mobile robot 200 and the object 402 as discussed above in the context of FIGS. 8, 9, 16 and 17. Reducing the projection of the object 402 from the body 203 toward the intersection 404 can occur while rotating this joint. In these and other cases, moving the sensor into the safety region 406 can occur while the object 402 is anterior relative to the body 203 and posterior relative to the legs 224a, 224b. Alternatively or in addition, moving the sensor into the safety region 406 can occur while the object 402 is anterior relative to the body 203 and lateral relative to the legs 224a, 224b. The method 300 can include reversing movement at the joint after determining that moving the object 402 into the safety region 406 is safe.

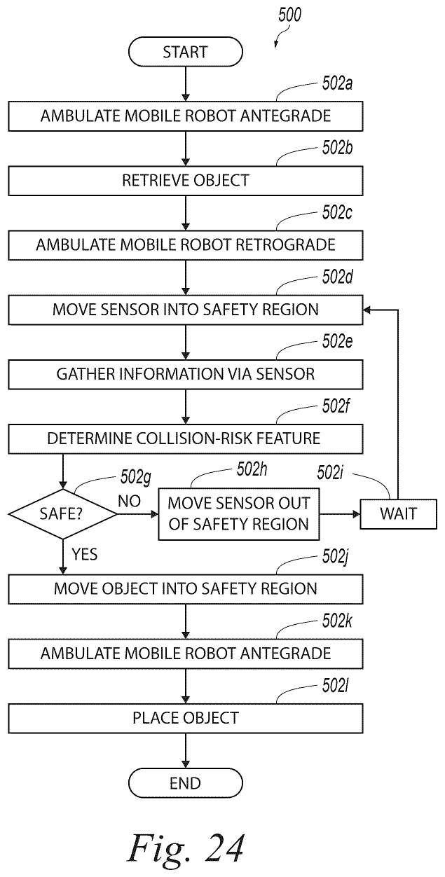

FIG. 24 is a block diagram corresponding to another method 500 in accordance with at least some embodiments of the present technology. As with the method 300, examples of the method 500 will be described with reference to the environment 100 and the mobile robot 200. With reference now to FIGS. 1-24 together, the method 500 can omit at least some operations related to reducing projection of the object 402 toward the intersection 404. The method 500 can include ambulating the mobile robot 200 antegrade within the aisle 400 to a picking location within the environment 100 (block 502a). The ambulating can be bipedal and via the legs 224a, 224b. The method 500 can further include retrieving the object 402 at the picking location (block 502b). In at least some cases, retrieving the object 402 includes moving the object 402 toward the body 203 via at least one of the arms 222a, 222b. For example, retrieving the object 402 can include extending the arms 222a, 222b anteriorly away from the body 203, gripping the object 402 between the end effectors 226a, 226b and retracting the arms 222a, 222b to pull the object 402 toward the body 203. This can occur while the mobile robot 200 is at the picking location. Then, the method 500 can include ambulating the mobile robot retrograde within the aisle 400 from the picking location to the intersection 404 (block 502c). Again, the ambulating can be bipedal and via the legs 224a, 224b. Furthermore, the ambulating can occur while the object 402 is in contact with the arms 222a, 222b. After the mobile robot 200 reaches the intersection 404, the method 500 can include operations corresponding to blocks 502d-502l in FIG. 24 the same as or similar to operations of the method 300 described above and corresponding to blocks 302c-302k in FIG. 5.

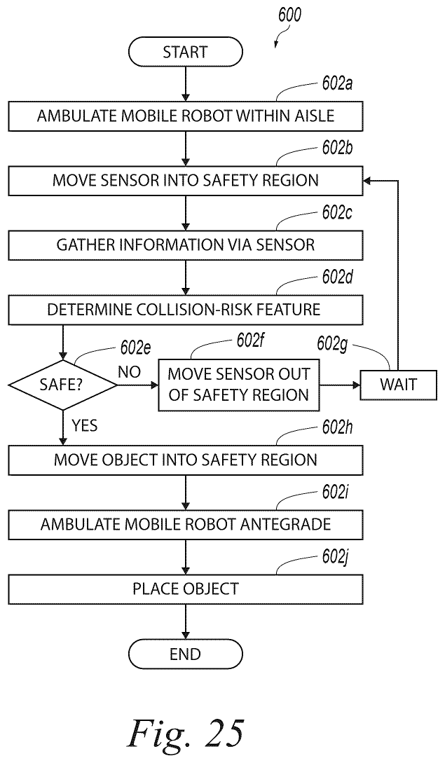

FIG. 25 is a block diagram corresponding to another method 600 in accordance with at least some embodiments of the present technology. As with the methods 300, 500, examples of the method 500 will be described with reference to the environment 100 and the mobile robot 200. With reference now to FIGS. 1-25 together, the method 600 can omit at least some operations of the method 300 related to reducing projection of the object 402 toward the intersection 404. Furthermore, the method 600 can omit at least some operations of the method 500 related to ambulating the mobile robot 200 retrograde from the picking location to the intersection 404. The method 600 can include ambulating (e.g., bipedally ambulating) the mobile robot 200 antegrade within the aisle 400 (block 602a). This can occur while the mobile robot 200 carries the object 402. Next, the method 600 can include moving a sensor of the mobile robot 200 into the safety region 406 (block 602b). This can occur while the object 402 is anterior relative to the body 203 and anterior relative to the legs 224a, 224b. Two approaches are possible to reduce or eliminate an associated collision risk at the safety region 406. In one example, the mobile robot 200 implements a deep-bow maneuver to move the head 212 into the safety region 406 while most or all of the object 402 remains in the aisle 400. This can include severely tilting a superior portion of the body 203 (e.g., the superior portion 206 of the torso 204) anteriorly relative to an inferior portion of the body 203 (e.g., the inferior portion 208 of the torso 204). This can move sensors at the elongate sensor bays 218d, 218e into the safety region 406. In at least some cases, this transitions the body 203 from being posterior to the object 402 to being superior to the object 402. Correspondingly, moving the sensors into the safety region 406 can occur while the body 203 is superior to the object 402. Once moved into the safety region 406, the sensors can have respective visibility regions sufficiently unobstructed to detect a human within the safety region 406.

In another example, the method 600 includes moving the object 402 into the safety region 406 while the end effectors 226a, 226b are at opposite respective sides of the object 402. Moving the object 402 into the safety region 406 can include ambulating the mobile robot 200 antegrade toward the safety region 406 and/or extending the arms 222a, 222b to move the object 402 and the end effectors 226a, 226b away from the body 203 and at least partially into the safety region 406. This can move sensors at the additional sensor bays 221c, 221d into the safety region 406. Once moved into the safety region 406, the sensors can have respective visibility regions sufficiently unobstructed to detect a human within the safety region 406. After moving at least one sensor into the safety region 406, the method 600 can include operations corresponding to blocks 602c-602j in FIG. 25 the same as or similar to operations of the method 300 described above and corresponding to blocks 302d-302k in FIG. 5.

### Examples of Electrical, Computer, and Software Systems

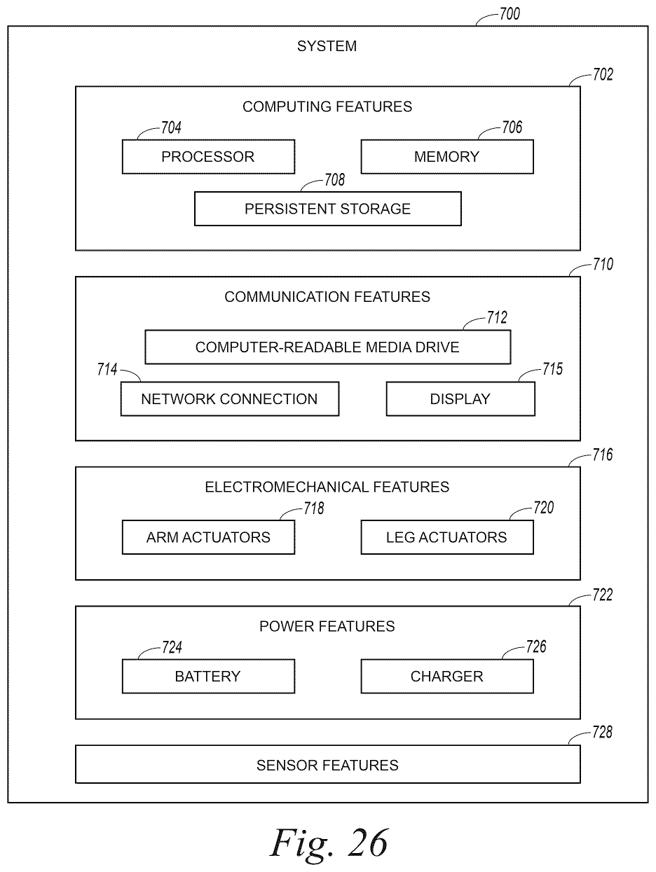

FIG. 26 is a block diagram depicting a system 700 including electrical, computer, and software features operably associated with a mobile robot in accordance with at least some embodiments of the present technology. The system 700 may be described in the context of the mobile robot 200 and with reference to FIGS. 2-4. When suitable, operations described elsewhere in this disclosure can be implemented at least partially via the devices and systems disclosed in this section. As shown in FIG. 26, the system 700 can include computing features 702. The computing features 702 can include a processor 704, such as one or more general-purpose or special-purpose integrated circuits including digital logic gates for executing programs or for otherwise processing data. The computing features 702 can further include memory 706, such as one or more integrated circuits for storing data in use. The memory 706 can include a multithreaded program, an operating system including a kernel, device drivers, etc. The computing features 702 can further include persistent storage 708, such as a hard drive for persistently storing data. Examples of data that can be stored by the persistent storage 708 include diagnostic data, sensor data, configuration data, environmental data, and current-state data. The computing features 702 can collectively define a computer configured to manage, control, receive information from, deliver information to, and/or otherwise usefully interact with other features of the system 700.

The system 700 can further include communication features 710. The communication features 710 can include a computer-readable media drive 712 for reading computer programs and/or other data stored on computer-readable media. As one example, the computer-readable media drive 712 can be a flash-memory drive. The communication features 710 can further include a network connection 714 for connecting the mobile robot 200 to other devices and systems, such as other mobile robots and/or other computer systems. The network connection 714 can be wired or wireless and can be via the Internet, a Local Area Network (LAN), a Wide Area Network (WAN), BLUETOOTH®, Wi-Fi®, a cellular-phone network, etc. The network connection 714 can include networking hardware, such as routers, switches, transmitters, receivers, computer-readable transmission media, etc. The communication features 710 can further include a display 715 (e.g., a touchscreen) and/or other suitable features for communicating with a user. The mobile robot 200 can use the communication features 710 for internal and/or external operations. Examples of these operations include interacting with systems that provide contextual information about the environment in which the mobile robot 200 operates and interacting with systems for changing operating conditions of the mobile robot 200.

The system 700 can further include electromechanical features 716. The electromechanical features 716 can include arm actuators 718 and leg actuators 720 operably associated with respective joints of the arms 222a, 222b and the legs 224a, 224b. In addition or alternatively, the electromechanical features 716 can include other suitable features for implementing mechanical action within the mobile robot 200. As shown in FIG. 26, the system 700 can further include power features 722, such as a battery 724 and a charger 726. The battery 724 can be a lithium-ion battery, a sodium-ion battery, or a battery of another suitable type. The charger 726 can include a connector compatible with a power source (e.g., a wall outlet, a charging station, etc.) and leads extending between the connector and the battery 724. In at least some cases, the mobile robot 200 is configured to operate wirelessly via the battery 724 and to recharge via the charger 726.

Finally, the system 700 can include sensor features 728 for capturing, providing, and/or analyzing information about the mobile robot 200 itself and/or the environment in which the mobile robot 200 operates. The sensor features 728 can include a vision sensor (e.g., a camera), a light sensor (e.g., a photoresistor), a sound sensor (e.g., a microphone), a location sensor (e.g., a Global Positioning System (GPS) sensor), a two-dimensional sensor, a three-dimensional sensor, and/or a proximity sensor, among other examples. Any of these examples of the sensor features 728 can be present at the elongate sensor bays 218a-218f, at the cylindrical sensor bay 220, at the additional sensor bays 221a-221c, and/or elsewhere in the mobile robot 200. Furthermore, within the body 203 and/or at one or more other suitable locations, the mobile robot 200 can include among the sensor features 728, an accelerometer, a gyroscope, a magnetometer, and/or a tilt sensor, among other examples. At the end effectors 226a, 226b, at the feet 228a, 228b, and/or at one or more other suitable locations, the mobile robot 200 can include among the sensor features 728, a contact sensor and/or a force sensor. In at least some cases, two or more different types of sensors are incorporated into a sensor assembly of the mobile robot 200. For example, an accelerometer, a gyroscope, and a magnetometer or another suitable combination of sensors can be incorporated into an inertial measurement unit (IMU) through which the mobile robot 200 can determine parameters such as acceleration, angular velocity, and orientation. The mobile robot 200 can include an IMU within the torso 204, within the head 212, and/or at one or more other suitable locations.

At one, some, or all of the arm actuators 718, at one, some, or all of the leg actuators 720, and/or at one or more other suitable locations, the mobile robot 200 can include among the sensor features 728, sensors that measure properties of corresponding joints. Such properties can include position, orientation (e.g., yaw, pitch, and roll), applied force (e.g., torque), elevation, mass, velocity, and acceleration, among other examples. The measurements of these properties can be direct or indirect. As an example of direct sensing, the mobile robot 200 may sense a torque acting on a given joint via a torque sensor operably associated with the joint, such as a torque sensor that outputs torque as function of current. As another example of direct sensing, the mobile robot 200 may sense a position of a given joint via an encoder operably associated with the joint. Any joint described herein should be construed as potentially including a torque sensor, encoder, and/or other suitable mechanism for direct sensing. As an example of indirect sensing, the mobile robot 200 may sense a position of a given one of the end effectors 226a, 226b or other feature based on perception data corresponding to the feature and other data corresponding to a reference. The mobile robot 200 can include one or more sensors in a sensor system, such as a vision system, a LiDAR system, a stereoscopic camera system, a SONAR system, etc. In at least some cases, the mobile robot 200 monitors itself and/or its environment in real-time or in near real-time. Moreover, the mobile robot 200 may use acquired sensor data as a basis for decision-making via the computing features 702.

Features of the system 700 can be connected to one another and/or to other features of the mobile robot 200 via suitable conductors, transmitters, receivers, circuitry, etc. While the system 700 configured as described may be used to support operation of the mobile robot 200, it should be appreciated that the mobile robot 200 may be operated using devices of various types and configurations and that such devices may have various components and levels of responsibility. For example, the mobile robot 200 may employ individual computer systems and/or controllers to manage discrete aspects of its operations, such as an individual computer system or controller to perform computer vision operations, a separate computer system or controller to perform power management, etc. In some cases, the mobile robot 200 employs the system 700 to control physical aspects of the mobile robot 200 according to one or more designated rules encoded in software. For example, these rules can include minimums and/or maximums, such as a maximum degree of rotation for a joint, a maximum speed at which a link is allowed to move, a maximum acceleration rate for the feet 228a, 228b, etc. The mobile robot 200 may include any number of mechanical aspects and associated rules, which may be based on or otherwise configured in accordance with the purpose of and/or functions performed by the mobile robot 200.

Software features of the system 700 and other computer systems described herein may take the form of computer-executable instructions, such as program modules executable by the computing features 702. Generally, program modules include routines, programs, objects, data structures, or the like configured to perform particular tasks based on source data, which may be encrypted. Control scripts may be implemented via a suitable language, such as C/C++ or Python® . The functionality of the program modules may be combined or distributed in various embodiments, including in cloud-based implementations. Furthermore, certain aspects of the present technology can be embodied in special purpose computers or data processors, such as in application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present technology, such as certain functions, may be described as being performed on a single device, these aspects, when suitable, can also be practiced in distributed computing environments where functions or modules are shared among different processing devices linked through a communications network such as a LAN, a WAN, or the Internet. In a distributed computing environment, program modules and other features may be located in both local and remote memory storage and in other devices, which may be in communication via one or more wired or wireless communication channels.

Aspects of the present technology may be stored or distributed on tangible computer-readable media, which can include volatile or non-volatile storage features, such as magnetically or optically readable computer media, hard-wired or preprogrammed chips (e.g., electrically erasable programmable read-only memory semiconductor chips), nanotechnology memory, or other computer-readable storage media. Alternatively, computer-implemented instructions, data structures, screen displays, and other data under aspects of the present technology may be distributed (encrypted or otherwise) over the Internet or over other networks (including wireless networks) on a propagated signal on a propagation medium (e.g., electromagnetic wave(s), sound wave(s), etc.) over a period of time. Furthermore, such data may be provided on an analog or digital network and packet switched, circuit switched, or managed under another suitable scheme. The term computer-readable storage medium as used herein does not, however, encompass signals themselves (e.g., propagating signals) or transitory media. One of ordinary skill in the art will recognize that various features of the mobile robot 200 and other devices and systems described herein may communicate via any number of wired or wireless communication techniques and that elements of such devices and systems may be distributed rather than located in a single monolithic entity. Finally, electrical and computing aspects of systems in accordance with various embodiments of the present technology may operate in environments or according to processes other than the examples of environments and processes described herein.

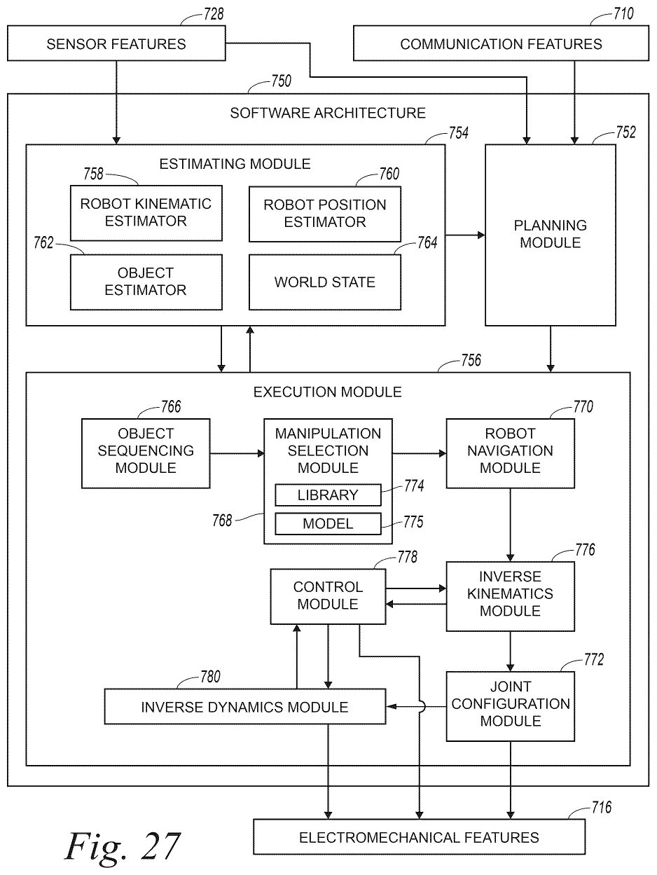

FIG. 27 is a block diagram depicting software architecture 750 and associated portions of the system 700. The software architecture 750 can be within the memory 706 or otherwise operably associated with any or all of the various features of the system 700 as described above. With reference to FIGS. 26 and 27 together, the software architecture 750 can include a planning module 752, an estimating module 754, and an execution module 756 operably associated with one other. The planning module 752 can be configured to relay or to generate a plan corresponding to an objective for the mobile robot 200 (e.g., unload all objects on a shelf, retrieve an object from a first location and move the object to a second location, etc.). In at least some cases, the planning module 752 receives information from the communication features 710 of the system 700 and relays or generates a plan based at least partially on the received information. For example, the planning module 752 may receive a task request from a user via the communication features 710 and relay the task request as a plan. As another example, the planning module 752 may receive a task request from a user via the communication features 710 and generate a plan related to the task request. As yet another example, the planning module 752 may generate a plan without receiving a task request from a user, such as at a predetermined time and/or in response to information about a current state of the mobile robot 200 or the environment received via the sensor features 728 of the system 700. Algorithms discussed above in connection with the methods 300, 500, 600 can be implemented in the software architecture 750 via the planning module 752.

The estimating module 754 can receive information from the sensor features 728 and generate estimates in real time or in near real time to inform generating and/or executing a plan. The estimating module 754 can include a robot kinematic estimator 758, a robot position estimator 760, an object estimator 762, and a world state 764. The robot kinematic estimator 758 can generate an estimate of a current kinematic state of the mobile robot 200 (e.g., balanced, off-balance, walking, standing, etc.) and estimates of positions of individual joints of the mobile robot 200. The robot position estimator 760 can generate a current estimate of a position of the mobile robot 200 within an environment. This position can be a set of coordinates and can be based on perception information, GPS information, and/or other information received by or generated by the mobile robot 200. Perception information potentially relevant to the position of the mobile robot 200 includes, among other examples, information corresponding to distances between the mobile robot 200 and landmarks in an environment and information corresponding to fiducial markings (e.g., AprilTags) carried by or otherwise associated with the landmarks. This information can be detected, for example, via a camera of the mobile robot 200. Furthermore, information can move between components of the estimating module 754. For example, the world state 764 can receive information from the robot kinematic estimator 758, the robot position estimator 760, and the object estimator 762. In addition or alternatively, the object estimator 762 can receive information from the robot kinematic estimator 758 and the robot position estimator 760.

The object estimator 762 can generate a current estimate of an object within an environment. In at least some cases, the estimate is a pose or other reference corresponding to a position and orientation of the object. As with the position of the mobile robot 200 itself, the position of an object can be a set of coordinates and can be based on perception information, GPS information, and/or other information received by or generated by the mobile robot 200. Perception information potentially relevant to the position of an object includes, among other examples, information corresponding to distances between the object and the mobile robot 200, distances between the object and landmarks in an environment, and information corresponding to fiducial markings (e.g., AprilTags) carried by or otherwise associated with the object. This information can be detected, for example, via a camera of the mobile robot 200. In at least some cases, the object estimator 762 uses information (e.g., sensor poses) from the robot kinematic estimator 758 and/or the robot position estimator 760 to inform generation of object estimates. This can be useful, for example, when a fiducial or other landmark in an environment is not visible. The object estimator 762 can be configured to update the world state 764 with object references and/or other information related to objects in an environment in which the mobile robot 200 operates. Furthermore, the object estimate can include an identification of an object and properties (e.g., dimensions) associated with that identification. For example, the object estimator 762 can include an object-recognition model (e.g., Detectron2 (Facebook AI Research) with Mask R-CNN implementation) that receives perception information (e.g., an image) corresponding to an object and outputs an object identification based at least partially on the perception information. The object estimator 762 can further include a lookup table for generating object properties based at least partially on this object identification.

The execution module 756 can be configured to receive a plan from the planning module 752 and estimates from the estimating module 754. The plan can include one or more motion commands and/or motion-command precursors. The execution module 756 can include an object sequencing module 766, a manipulation selection module 768, a robot navigation module 770, and a joint configuration module 772. The planning module 752 can be configured to send a plan to the object sequencing module 766, to the manipulation selection module 768, to the robot navigation module 770, or to the joint configuration module 772 based on attributes of the plan. For example, when a plan includes explicit instructions for positions of the electromechanical features 716 of the system 700, the planning module 752 can send the plan to the execution module 756 via the joint configuration module 772. As another example, when a plan does not involve manipulating an object, the planning module 752 can send the plan to the execution module 756 via the robot navigation module 770. As yet another example, when a plan concerns only one object and the object is remote to the mobile robot 200, the planning module 752 can send the plan to the execution module 756 via the manipulation selection module 768. As a final example, when a plan concerns multiple objects remote to the mobile robot 200, the planning module 752 can send the plan to the execution module 756 via the object sequencing module 766.

The object sequencing module 766 can receive one or more estimates from the estimating module 754 and can generate a sequence in which multiple objects are to be manipulated. For example, when the object sequencing module 766 receives a plan to unload a shelf, the object sequencing module 766 can query the estimating module 754 for current locations of objects on the shelf. The object sequencing module 766 can then assign the objects an order, convert the order into a queue, and pass the queue to the manipulation selection module 768. The manipulation selection module 768 can include a library 774 including manipulation primitives and/or sequences of manipulation primitives that can be used to manipulate an object. The manipulation selection module 768 can select manipulation primitives and/or sequences for a given object based on contextual information, such as information about the object and/or information about the environment. In addition or alternatively, the manipulation selection module can include a model 775 that outputs manipulation estimates based on contextual information. The robot navigation module 770 can generate targets for different parts of the mobile robot 200 further to a manipulation portion or other portions of a plan being executed. Examples of targets include positions of the feet 228a, 228b in the environment, positions of the end effectors 226a, 226b in the environment, etc. The robot navigation module 770 can update these targets continuously or near continuously based on information from the estimating module 754. The execution module 756 can further include an inverse kinematics module 776 that translates the targets from the robot navigation module 770 into joint configurations throughout the mobile robot 200.

The execution module 756 can also include a control module 778 that receives joint configurations from the inverse kinematics module 776 and generates joint parameters (e.g., positions, velocities, accelerations, etc.) to be executed by the mobile robot 200 via the electromechanical features 716 of the system 700 to achieve these joint configurations. Through continuous or near-continuous communication with the inverse kinematics module 776, the control module 778 can modify the joint parameters to at least partially compensate for deviations as the mobile robot 200 executes the joint configurations. The inverse kinematics module 776 can send other joint configurations not subject to active control to the joint configuration module 772 directly. Similar to the control module 778, the joint configuration module 772 can generate joint parameters (e.g., positions, velocities, accelerations, etc.) to be executed by the mobile robot 200 to achieve joint configurations received from the inverse kinematics module 776 or from the planning module 752.

Finally, the execution module 756 can include an inverse dynamics module 780 that receives joint parameters from the control module 778 and from the joint configuration module 772. The inverse dynamics module 780 can track a desired wrench of the mobile robot 200 and its relationship with objects in the environment. In at least some cases, the inverse dynamics module 780 references a map of robot positions and wrenches to joint torques. Based at least partially on tracking these joint torques, the inverse dynamics module 780 can modify joint parameters to achieve a desired result. For example, the inverse dynamics module 780 may modify joint parameters from the control module 778 and from the joint configuration module 772 to maintain contact between the end effectors 226a, 226b and an object as the mobile robot 200 carries the object. The inverse dynamics module 780 can then send modified joint parameters to the electromechanical features 716 of the system 700 for execution. For configurations that do not involve dynamic interaction with the environment, the control module 778 and the joint configuration module 772 can send joint parameters directly to the electromechanical features 716 for execution.

With reference to FIGS. 26 and 27 together, suitable software components disclosed herein can be part of a distributed system or component thereof or implemented as one or more network-based services. For example, a compute cluster within a computing service may present computing or storage services or other types of services that employ any distributed computing systems described herein to clients as network-based services. In some embodiments, a network-based service may be implemented by a software or hardware system designed to support interoperable machine-to-machine interaction over a network. A network-based service may have a gateway described in a machine-processable format. Other systems may interact with the network-based service in a manner prescribed by the description of the network-based service's gateway. For example, the network-based service may define various operations that other systems may invoke. Relatedly, the network-based service may define a particular API to which other systems may be expected to conform when requesting the various operations. In the cloud provider network context, APIs may provide a gateway for customers to access cloud infrastructure by allowing customers to obtain data from and/or to cause actions within the cloud provider network, enabling the development of applications that interact with resources and services hosted in the cloud provider network. APIs can also enable different services of the cloud provider network to exchange data with one another.

In a distributed system, some or all of the software architecture 750 and other software described herein can be executed remotely from the mobile robot 200. For example, the mobile robot 200 can be configured to collect raw sensor data via the sensor features 728 of the system 700 and to transmit some or all of this raw sensor data to a remote server in real time or near real time for processing. The mobile robot 200 can then receive joint commands and/or other products of this processing via communication with the server. In these and other cases, computing operations can be allocated among local and remote computing systems depending on factors such as computing demand, available computing resources, time sensitivity of computing products, etc. Moreover, even the sensor features 728 can be remote from the mobile robot 200 in certain cases. For example, a remote sensor may track its reference frame relative to a local sensor of the mobile robot 200 and may communicate that reference frame with sensor data it collects at any given time. A server receiving the sensor data can then use the relationship between the reference frame of the local sensor and the reference frame of the remote sensor to generate output in a reference frame compatible with processes that rely on sensor data from the local sensor only. Alternatively, in a non-distributed system, all information processing and command execution can occur locally at the mobile robot 200 or other local hardware depending on the implementation.

### Conclusion

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like are used throughout this disclosure to mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “including two arms” means including at least two arms. References herein to any of receiving, determining, generating, and selecting information in accordance with various embodiments of the present technology encompass, when feasible, the others of receiving, determining, generating, and selecting the information and indicate that such operations can occur at least partially via the relevant computing subsystem.

Directional terms, such as “upper,” “lower,” “front,” “back,” “vertical,” and “horizontal,” may be used herein to express and clarify the relationship between various structures. It should be understood that such terms do not denote absolute orientation. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

I/We claim:

1. A method comprising:
ambulating, via legs of a mobile robot that carry a body of the mobile robot, the mobile robot within an aisle of an environment toward an intersection of the environment between the aisle and a safety region of the environment while the mobile robot carries an object and while the object projects from the body toward the intersection;
reducing a projection of the object from the body toward the intersection after ambulating the mobile robot toward the intersection;
moving a sensor of the mobile robot into the safety region after reducing the projection of the object from the body toward the intersection;
gathering, via the sensor and while the sensor and the object are in the safety region and the aisle, respectively, information relevant to a collision risk at the safety region; and
moving the object into the safety region based at least partially on the information.

2. The method of claim 1, wherein:
the method further comprises determining, via a computing system operably associated with the mobile robot, a collision-risk feature of the safety region based at least partially on the information; and
moving the object into the safety region includes moving the object into the safety region based at least partially on the collision-risk feature.

3. The method of claim 1, wherein:
gathering the information includes gathering a proximity of a human within the safety region; and
moving the object into the safety region includes moving the object into the safety region based at least partially on the proximity of the human.

4. The method of claim 1, wherein:
gathering the information includes gathering a trajectory of a human within the safety region; and
moving the object into the safety region includes moving the object into the safety region based at least partially on the trajectory of the human.

5. The method of claim 1, wherein:
gathering the information includes gathering a speed of a human within the safety region; and
moving the object into the safety region includes moving the object into the safety region based at least partially on the speed of the human.

6. The method of claim 1, wherein:
the aisle is a first aisle;
the safety region is a portion of a second aisle of the environment neighboring the first aisle at the intersection; and
the second aisle is perpendicular to the first aisle.

7. The method of claim 1, wherein:
ambulating the mobile robot toward the intersection includes ambulating the mobile robot toward the intersection while the object is anterior relative to the body and anterior relative to the legs; and
moving the sensor into the safety region includes moving the sensor into the safety region while the object is anterior relative to the body and posterior relative to the legs.

8. The method of claim 1, wherein:
ambulating the mobile robot toward the intersection includes ambulating the mobile robot toward the intersection while the object is anterior relative to the body and anterior relative to the legs; and
moving the sensor into the safety region includes moving the sensor into the safety region while the object is anterior relative to the body and lateral relative to the legs.

9. The method of claim 1, wherein:
ambulating the mobile robot toward the intersection includes ambulating the mobile robot toward the intersection while the object is anterior relative to the body and anterior relative to the legs; and
moving the sensor into the safety region includes moving the sensor into the safety region while the object is posterior relative to the body and posterior relative to the legs.

10. The method of claim 1, wherein moving the sensor into the safety region includes moving the sensor into the safety region while tilting a superior portion of the body relative to an inferior portion of the body and while the mobile robot carries the sensor via the superior portion of the body and while the legs carry the body via the inferior portion of the body.

11. The method of claim 10, wherein tilting the superior portion of the body includes tilting the superior portion of the body while feet of the mobile robot are planted in the aisle and while the feet carry the body via the legs.

12. The method of claim 11, wherein tilting the superior portion of the body includes tilting the superior portion of the body anteriorly relative to the body.

13. The method of claim 11, wherein tilting the superior portion of the body includes tilting the superior portion of the body laterally relative to the body.

14. The method of claim 11, wherein tilting the superior portion of the body includes tilting the superior portion of the body posteriorly relative to the body.

15. The method of claim 14, wherein tilting the superior portion of the body includes tilting the superior portion of the body while extending arms of the mobile robot to move the object away from the body.

16. The method of claim 1, wherein reducing the projection of the object from the body toward the intersection includes reducing the projection of the object from the body toward the intersection while stepping with one of the legs.

17. The method of claim 1, wherein reducing the projection of the object from the body toward the intersection includes reducing the projection of the object from the body toward the intersection while rotating a joint of the mobile robot through which the body is rotatably connected to the legs.

18. The method of claim 1, wherein:
reducing the projection of the object from the body toward the intersection includes reducing the projection of the object from the body toward the intersection while rotating arms of the mobile robot relative to the body and while the mobile robot carries the object via the arms; and
rotating the arms relative to the body moves the object from anterior relative to the body to superior relative to the body.

19. The method of claim 18, wherein rotating the arms relative to the body moves the object from superior relative to the body to posterior relative to the body.

20. The method of claim 1, wherein ambulating the mobile robot toward the intersection includes ambulating the mobile robot bipedally toward the intersection.
